(19) United States
(12) Patent Application Publication
(10) Pub. No.: US 2004/0129806 A1
(43) Pub. Date: Jul. 8, 2004

(54) Fuel injection valve

(76) Inventors: G?uuml;nter Dantes, Eberdingen (DE); Detlef Nowak, Untergruppenbach (DE)

Correspondence Address: KENYON & KENYON, ONE BROADWAY, NEW YORK, NY, 10004, US

(21) Appl. No.: 10/432,947

(22) PCT Filed: Sep. 7, 2002
(86) PCT No.: PCT/DE02/03338

(30) Foreign Application Priority Data
Oct. 2, 2001 (DE) 101 48 597.2

(51) Int. Cl. F02M 61/00

(52) U.S. Cl. 239/533.12

(57) ABSTRACT

A fuel injector (1) for the direct injection of fuel into the combustion chamber of an internal combustion engines includes an actuator (10), a valve needle (3), which is able to be activated by the actuator (10) to actuate a valve-closure member (4), which forms a sealing seat together with a valve-seat surface (6) formed on a valve-seat member (5); and has a plurality of spray-discharge orifices (7) formed in the valve-seat member (5). A groove-type surface structure (34) is formed at an end face (35) of the valve-seat member (5) facing the combustion chamber.

### BACKGROUND INFORMATION

The present invention is directed to a fuel injector of the type set forth in the main claim.

From DE 198 04 463 A1, a fuel-injection system for a mixture-compressing internal combustion engine having external ignition is known, which includes a fuel injector injecting fuel into a combustion chamber formed by a piston/cylinder construction and has a spark plug projecting into the combustion chamber. The fuel injector is provided with at least one row of spray-discharge orifices distributed over the circumference of the fuel injector. By a selective injection of fuel via the spray-discharge orifices, a jet-controlled combustion method is realized by a mixture cloud being formed using at least one jet.

A particular disadvantage of the fuel injector known from the aforementioned printed publication is the deposit formation in the spray-discharge orifices, these deposits clogging the orifices and causing an unacceptable reduction in the flow rate through the injector. This leads to malfunctions of the internal combustion engine.

### SUMMARY OF THE INVENTION

In contrast, the fuel injector according to the present invention, having the characterizing features of the main claim, has the advantage over the related art that at an end face of the valve-seat member of the fuel injector facing the combustion chamber of the internal combustion engine, a groove-type surface structure is formed which prevents fuel from depositing in the region of the spray-discharge orifices, thereby avoiding a clogging of the spray-discharge orifices due to coking residue.

Advantageous further developments of the fuel injector specified in the main claim are rendered possible by the measures delineated in the dependent claims.

It is particularly advantageous that any number of grooves may be selected, starting with a single groove, originating from any selected spray-discharge orifice, and increasing up to a number that corresponds to the number of spray-discharge orifices.

In an advantageous manner, the groove-type surface structure may be produced at the same time as the valve-seat member or applied thereon retroactively.

Furthermore, it is advantageous that the groove-type surface structure is able to be produced in a simple and cost-effective manner by mechanical machining, such as turning on a lathe or by chemical processing, such as etching.

### BRIEF DESCRIPTION OF THE DRAWINGS

Exemplary embodiments of the present invention are shown in simplified form in the drawing and are elucidated in greater detail in the following description.

The figures show:

FIG. 1 a schematic section through a first exemplary embodiment of a fuel injector configured according to the present invention, in an overall view;

FIG. 2A an enlarged schematic plan view of a first exemplary embodiment of a valve-seat member configured according to the measures of the present invention, for the fuel injector represented in FIG. 1.

FIG. 2B an enlarged schematic plan view of a second exemplary embodiment of a valve-seat member configured according to the measures of the present invention, for the fuel injector represented in FIG. 1.

### DESCRIPTION OF THE EXEMPLARY EMBODIMENTS

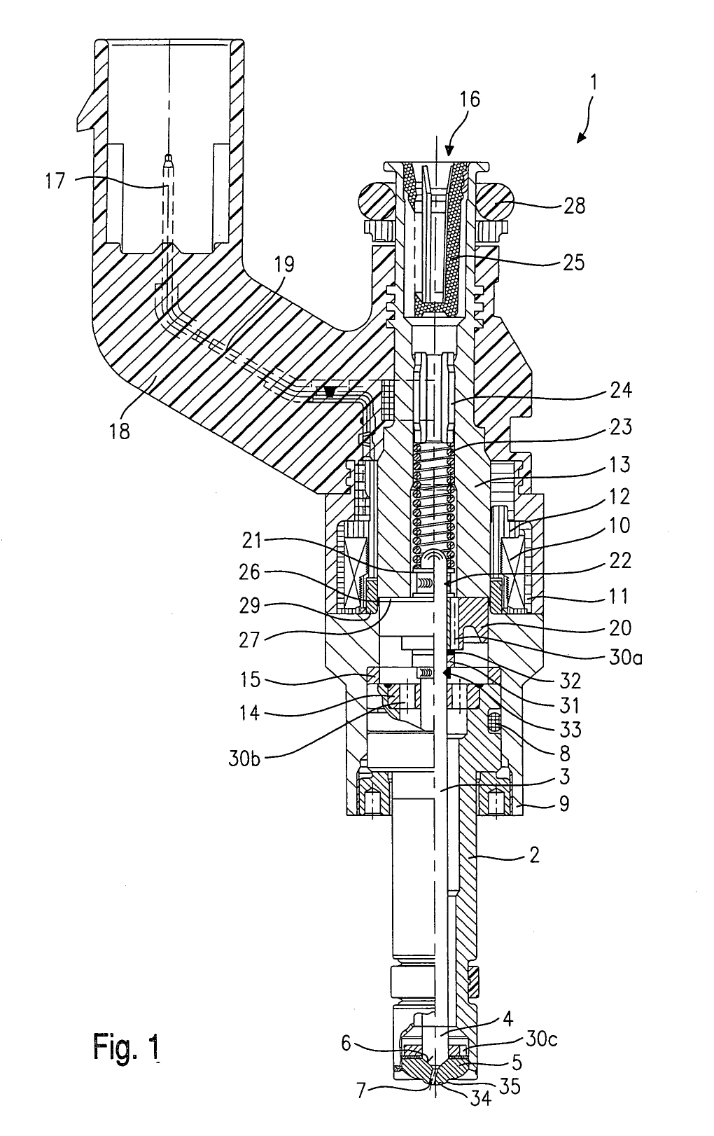

In a part-sectional representation, FIG. 1 shows an exemplary embodiment of a fuel injector 1 designed according to the present invention. It is in the form of a fuel injector 1 for fuel-injection systems of mixture-compressing internal combustion engines having external ignition. Fuel injector 1 is suited for the direct injection of fuel into a combustion chamber (not shown) of an internal combustion engine.

Fuel injector 1 is made up of a nozzle body 2 in which a valve needle 3 is positioned. Valve needle 3 is in operative connection with a valve-closure member 4, for instance, via a welding seam 41. The valve-closure member 4 cooperates with a valve-seat surface 6, located on a valve-seat member 5, to form a sealing seat. The fuel injector in the exemplary embodiment is an inwardly opening fuel injector 1 having a plurality of spray-discharge orifices 7 which are arranged in at least one circle which is concentric to the axis of valve-seat member 5.

Seal 8 seals nozzle body 2 from an outer pole 9 of a magnetic coil 10 functioning as an actuator of valve needle 3. Magnetic coil 10 is encapsulated in a coil housing 11 and wound on a coil brace 12, which rests against an inner pole 13 of magnetic coil 10. Inner pole 13 and outer pole 9 are separated from one another by a gap 26 and braced against a connecting member 29. Magnetic coil 10 is energized via a line 19 by an electric current which may be supplied via an electrical plug contact 17. A plastic extrusion coat 18, which can be extruded onto inner pole 13, encloses plug contact 17.

Valve needle 3 is guided in a valve-needle guide 14, which is disk-shaped. A paired adjustment disk 15 is used to adjust the (valve) lift. On the other side of adjustment disk 15 is an armature 20 which, via a first flange 21, is connected by force-locking to valve needle 3, which in turn is connected to first flange 21 by a welding seam 22.

Braced on first flange 21 is a restoring spring 23 which, in the present design of fuel injector 1, is provided with an initial stress by a sleeve 24.

On the discharge-side of armature 20 is a second flange 31 which is used as lower armature stop. It is connected to valve needle 3 in force-locking manner via a welding seem 33. An elastic intermediate ring 32 is positioned between armature 20 and second flange 31 to damp armature bounce during closing of fuel injector 1.

Fuel channels 30a through 30c run in valve-needle guide 14, in armature 20 and valve-seat member 5. The fuel is supplied via a central fuel feed 16 and filtered by a filter element 25. A seal 28 seals fuel injector 1 from a distributor line (not shown further).

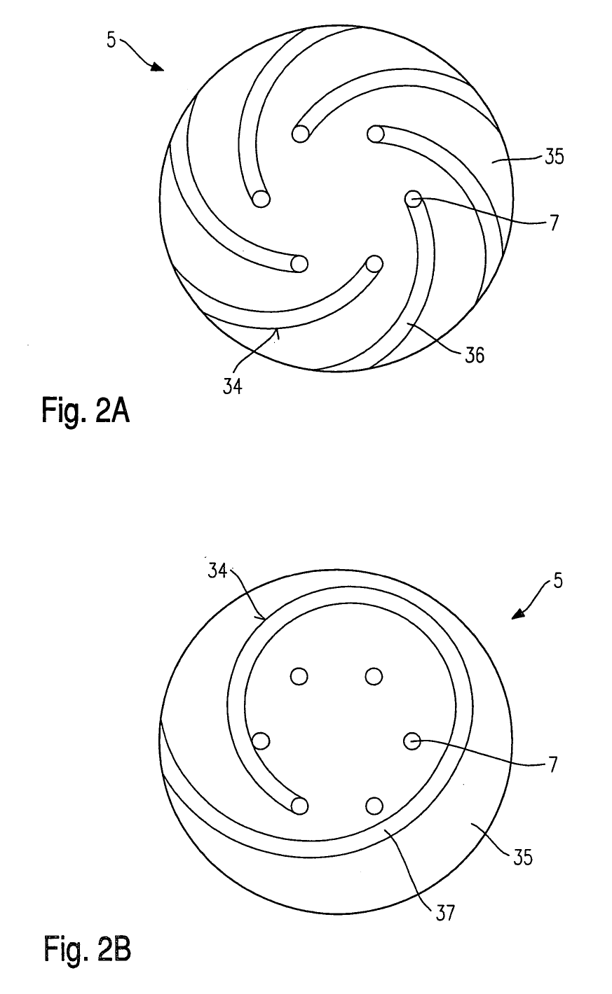

On an end face 35 of valve-seat member 5 facing the combustion chamber of the internal combustion engine, fuel injector 1 according to the present invention has a groove-type surface structure 34 which extends from spray-discharge orifices 7, arranged in at least one circle, radially toward the outside. Due to groove-type surface structure 34, fuel depositing on the tip of fuel injector 1 during the injection procedure, is carried away from spray-discharge orifices 7, so that the coking tendency of spray-discharge orifices 7 is reduced. In this manner, malfunctions of fuel injector 1, due to clogging of spray-discharge orifices 7, and an impermissible reduction in the fuel flow rate are avoided. The measures according to the present invention are represented in more detail in FIGS. 2A and 2B and explained in the following description.

In the rest state of fuel injector 1, restoring spring 23 acts upon first flange 21 at valve needle 3, contrary to a lift direction, in such a way that valve-closure member 4 is sealingly retained against valve seat 6. Armature 20 rests on intermediate ring 32, which is supported on second flange 31. In response to excitation of magnetic coil 10, it builds up a magnetic field which moves armature 20 in the lift direction, against the spring force of restoring spring 23. Armature 20 carries along first flange 21, which is welded to valve needle 3, and thus valve needle 3, in the lift direction as well. Valve-closure member 4, being in operative connection with valve needle 3, lifts off from valve seat surface 6, thereby discharging fuel at spray-discharge orifices 7.

When the coil current is turned off, once the magnetic field has sufficiently decayed, armature 20 falls away from inner pole 13, due to the pressure of restoring spring 23 on first flange 21, whereupon valve needle 3 moves in a direction counter to the lift. As a result, valve closure member 4 comes to rest on valve-seat surface 6, and fuel injector 1 is closed. Armature 20 comes to rest against the armature stop formed by second flange 31.

FIGS. 2A and 2B, in an enlarged schematic plan view of the spray-discharge side end of fuel injector 1 shown in FIG. 1, show two exemplary embodiments of the measures according to the present invention.

As already briefly mentioned in the description relating to FIG. 1, fuel injector 1, in the region of valve-seat member 5, at an end face 35 facing the combustion chamber of the internal combustion engine, has a groove-type surface structure-34, which is used to carry away fuel depositing in the region of spray-discharge orifices 7. End face 35 preferably has a convexly shaped conical or calotte-type design. The groove-type surface structure 34 according to the present invention makes it possible to reduce the coking of spray-discharge orifices 7. Since the diameter of spray-off orifices 7 is, typically, approximately 100 μm, the danger of the spray-off orifices getting clogged by deposits forming over time and the flow rate being untolerably limited as a consequence, is relatively high. This is the result, in particular, of the high temperatures during the through-ignition of the mixture cloud injected into the combustion chamber, since fuel components thereby are deposited on the tip of fuel injector 1. By creating the groove-type surface structure 34, fuel remaining in the exit region of spray-discharge orifices 7 is able to be carried away, so that spray-discharge orifices 7 will not get clogged by coking residue.

FIG. 2A shows a first exemplary embodiment of a groove-type surface structure 34. In the present exemplary embodiment, the number of spray-discharge orifices 7 amounts to six. They are arrayed in a circle that is concentrically arranged with respect to a center axis of fuel injector 1 and/or valve-seat member 5. A groove 36, which has a directional component that is directed radially outward from the respective spray-discharge orifice 7, extends from each spray-discharge orifice 7. Grooves 36 are bent to a greater or lesser degree, so as to ensure an optimal removal of fuel which has deposited in the region of spray-discharge orifices 7. Alternatively, it is possible to reduce the number of grooves 36 in order to keep the manufacturing cost low, so that, for instance, only every second spray-discharge orifice 7 is in connection with a groove 36.

Grooves 36 may have any desired cross section, but a u-shaped cross section is the most advantageous for reasons of production engineering and fluid mechanics. The cross section may also, for instance, taper toward the radially outer ends 38 of grooves 36; moreover, ends 38 may also be widened. Grooves 36 are produced, for instance, by turning on a lathe during the production of valve-seat member 5. It is even possible to produce them retroactively by a chemical process such as etching.

In the same view as in FIG. 2A, FIG. 2B shows a second exemplary embodiment of valve seat member 5 of a fuel injector 1 configured according to the present invention.

As in the first exemplary embodiment shown in FIG. 2A, fuel injector 1 has six spray-discharge orifices 7 which are likewise arrayed in a circle. In the present second exemplary embodiment, the fuel is carried away by a single groove 37, which starts from only a single spray-discharge orifice 7 and, in a helical manner, extends radially outward in such a way that all spray-discharge orifices 7 lie radially inside single groove 37. Alternatively, it would also be possible to locate spray-discharge orifices 7 along a helical line extending in parallel to helical single groove 37.

Single groove 37 must completely circle spray-discharge orifices 7 at least once so as to ensure that the fuel is carried away from all spray-discharge orifices 7. As in the first exemplary embodiment, single groove 37 may be produced during the manufacture of valve-seat member 5 by turning on a lathe or be introduced retroactively by a chemical or mechanical procedure. A u-shaped cross section, perhaps with an enlarged and/or flattened end 38, is another possible cross-sectional shape.

The present invention is not limited to the exemplary embodiments shown but applicable to any number of spray-discharge orifices 7, which may be located on the discharge-side end of fuel injector 1 as desired, and also for any number of grooves 36 and designs of fuel injectors 1.

What is claimed is:

1. A fuel injector (1) for the direct injection of fuel into the combustion chamber of an internal combustion engines having an actuator (10), a valve needle (3), which is able to be activated by the actuator (10) to actuate a valve-closure member (4), which, together with a valve-seat surface (6) formed at a valve-seat member (5), forms a sealing seat; and having a plurality of spray-discharge orifices (7) formed in the valve-seat member (5),
wherein a groove-type surface structure (34) is formed at an end face (35) of the valve-seat member (5) facing the combustion chamber.

2. The fuel injector as recited in claim 1,
wherein the groove-type surface structure (34) is embodied in the form of grooves (36) which are in connection to the spray-discharge orifices (7).

3. The fuel injector as recited in claim 2,
wherein the grooves (36) have a directional component that is directed radially outward.

4. The fuel injector as recited in claim 3,
wherein the grooves (36) have a curved shape

5. The fuel injector as recited in one of claims 2 through 4,
wherein the number of grooves (36) is less than, or equal to, the number of spray-discharge orifices (7).

6. The fuel injector as recited in claim 1,
wherein the groove-type surface structure (34) is embodied in the form of a single groove (37)

7. The fuel injector as recited in claim 6,
wherein the single groove (37) is in connection to only one spray-discharge orifice (7).

8. The fuel injector as recited in claim 7,
wherein the single groove (37) extends radially outward in a helical manner.

9. The fuel injector as recited in claim 8,
wherein the single groove (37) extends on the valve-seat member (5) in such a way that the spray-discharge orifices (7) discharge inside the single groove (37).

10. The fuel injector as recited in one of claims 1 through 9,
wherein the groove-type surface structure (34) is produced by turning on a lathe or etching.
